(19) United States
(12) Patent Application Publication
(10) Pub. No.: US 2017/0270044 A1
(43) Pub. Date: Sep. 21, 2017

(54) Active Storage Unit and Array

(71) Applicant: Agency for Science, Technology and Research, Singapore (SG)

(72) Inventors: Hong YANG, Singapore (SG); Khai Leong YONG, Singapore (SG); Dee Meng KANG, Singapore (SG)

(21) Appl. No.: 15/506,565

(22) PCT Filed: Oct. 2, 2015
(86) PCT No.: PCT/SG2015/050366

§ 371 Date: Feb. 24, 2017

(30) Foreign Application Priority Data
Oct. 3, 2014 (SG) 10201406320V

(51) Int. Cl. G06F 12/0804; G06F 3/06

(52) U.S. Cl. CPC G06F 12/0804; G06F 3/0617; G06F 3/0647; G06F 3/0685; G06F 2212/1032

(57) ABSTRACT

An active storage unit and an active storage array are provided. The active storage unit includes an active control board having a processor, at least one internal memory module communicatively coupled to the processor, and a reconfigurable logic circuit communicatively coupled to the processor for programming the active storage unit. The active storage unit also includes a plurality of storage devices communicatively coupled to the active control board.

### FIELD OF INVENTION

The present invention relates broadly to active storage units and arrays, and particularly but not exclusively, to active storage units and arrays configured and structured to eliminate use of storage servers and redundant array of independent disks (RAID) controller subsystems.

### BACKGROUND

Conventional data centers usually use storage devices or volumes that have little or no intelligence capabilities. These storage devices or volumes are deemed as dummy devices and are only able to perform simple read/write functions. To scalably use them in the data centers, a stack of system software is typically required in a storage server to abstract the block-based storage device. A RAID controller is also commonly used to group and manage multiple storage devices into various logical volumes.

FIG. 1a shows a block diagram illustrating a conventional storage architecture. FIG. 1b shows a flow chart illustrating typical operations of the storage architecture of FIG. 1a. Here, two storage servers and two storage array enclosures are shown, but the number may vary depending on the needs of the data center. Each storage array enclosure includes a plurality of storage devices, such as hard disk drives (HDDs), controlled by the respective storage server. In another configuration, the storage enclosure can contain RAID controller to provide logical volumes abstraction of the underlying HDDs and data protection against possible disk failures. Typically, at step 1, a client device requests a data map from a metadata server. At step 2, the metadata retrieves the data map and sends the same to the client device. At step 3a, the client device sends data to the first storage server and data is stripped into blocks. At step 4a/4b/4c/4d, the data blocks are written to the storage devices of the first storage array enclosure. In some systems, in parallel to step 3a, at step 3b, the client device sends data to the second storage server and data is again stripped into blocks. At step 5a/5b/5c/5d, the data blocks are written to the storage devices of the second storage array enclosure.

The conventional architecture of separating data storage from data management and processing suffers from cost and scalability issues. With more data in data centers, more storage servers are required to manage the additional storage devices and to provide storage abstraction. This increases the cost, not only in terms of hardware expense but also in terms of maintenance, of the large number of servers. On the other hand, if the number of storage servers remains the same, data management and performance at the storage node will decrease, as the same amount of resources in the storage node has to process a larger amount of storage data. Thus, sacrifices normally have to be made in order to balance system performance and cost control.

A need therefore exists to provide a storage architecture that seeks to address at least some of the above problems.

### SUMMARY

According to an aspect of the present invention, there is provided an active storage unit comprising:

an active control board comprising a processor, at least one internal memory module communicatively coupled to the processor, and a reconfigurable logic circuit communicatively coupled to the processor for programming the active storage unit; and

a plurality of storage devices communicatively coupled to the active control board.

The active control board may further comprise a non-volatile memory module communicatively coupled to the processor and configured to provide a cache for data stored in the storage devices.

The processor may be configured to write volatile data to the non-volatile memory module in an event of a power disruption.

The active storage unit may further comprise a back-up power supply configured to provide emergency power to the active storage unit in the event of a power disruption.

The non-volatile memory module may comprise a solid state drive.

The active control board may be configured to interpret object and file transfer protocols into actual data transfer to or from the storage devices.

The active control board may comprise an operating system configured to run distributed file system software.

The storage devices may comprise at least one of a group consisting of hard disk drives (HDDs), hybrid HDDs, solid state drives (SSDs) and hybrid SSDs.

The active control board may further comprise a non-volatile random access memory (NVRAM) controller configured to control at least one NVRAM module connected thereto.

The active control board may further comprise an inter-integrated circuit (I²C) communicatively coupled to the processor.

According to another aspect of the present invention, there is provided an active storage array comprising:

one or more active storage units, each active storage unit comprising:
an active control board comprising a processor, at least one internal memory module communicatively coupled to the processor, and a reconfigurable logic circuit communicatively coupled to the processor for programming the active storage unit, and
a plurality of storage devices communicatively coupled to the active control board; and

one or more switch control boards interfacing between the one or more active storage units and external devices, thereby allowing data operations directly between the external devices and the one or more active storage units.

The active storage array may further comprise a back plane board configured to receive the one or more active storage units and the one or more switch control boards, wherein the one or more active storage units and the one or more switch control boards are hot-pluggable to the back plane board.

The active storage array may comprise a plurality of switch control boards each interfacing between respective one or more active storage units and the external devices and each comprising a network switch communicatively coupled to a switch controller module.

The plurality of switch control boards may be configured to cooperate with each other, via the network switch, to form a distributed active storage array.

The one or more switch control boards may each comprise a chassis management processor communicatively coupled to the network switch and configured to power on the one or more active control boards in phases via a power switch disposed in each of the one or more active control boards.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1a shows a block diagram illustrating a conventional storage architecture.

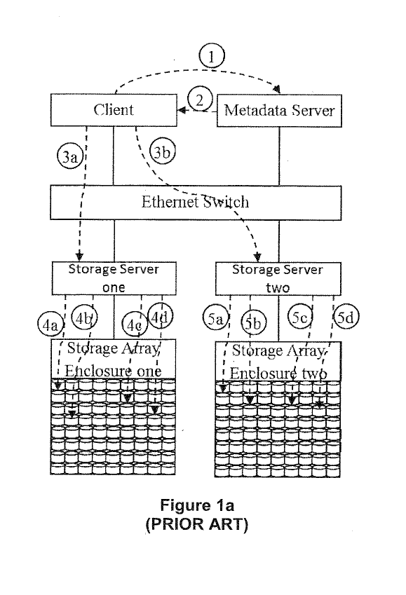

FIG. 1b shows a flow chart illustrating typical operations of the storage architecture of FIG. 1a.

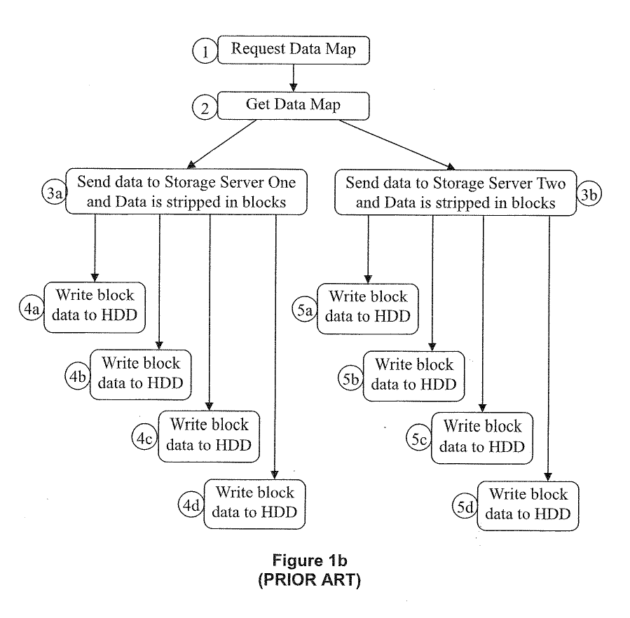

FIG. 2 shows a block diagram illustrating a distributed active storage architecture according to an example embodiment.

FIG. 3a shows a logic-level block diagram illustrating an active storage array according to an example embodiment.

FIG. 3b shows an example hardware-level block diagram of the active storage array of FIG. 3a.

FIG. 3c shows a flow chart illustrating example diagnostic operations of the active storage array of FIG. 3a.

FIG. 4a shows a logic-level block diagram of an active storage unit according to an example embodiment.

FIG. 4b shows an example hardware-level block diagram of the active storage unit of FIG. 4a.

FIG. 4c shows a flow chart illustrating a plug-and-play capability of the active storage unit of FIG. 4a.

FIG. 4d shows a flow chart illustrating an example data transfer process in the active storage unit of FIG. 4a.

FIG. 5 shows a hardware-level block diagram of a switch control board according to an example embodiment.

FIG. 6 shows a hardware-level block diagram of a back plane board according to an example embodiment.

FIG. 7 shows a hardware-level block diagram of a power path board according to an example embodiment.

FIG. 8 shows a hardware-level block diagram of the active storage unit according to another example embodiment.

FIG. 9 shows a hardware-level block diagram of the active storage unit according to another example embodiment.

FIG. 10 shows a hardware-level block diagram of the active storage unit according to another example embodiment.

FIG. 11 shows a hardware-level block diagram of the active storage unit according to another example embodiment.

FIG. 12 shows a hardware-level block diagram of the active storage unit according to yet another example embodiment.

FIG. 13 shows a block diagram illustrating a physical layout of the active storage array according to an example embodiment.

### DETAILED DESCRIPTION

The example embodiments provide an intelligent storage array enclosure (ISAE) system equipped with processing and memory resources to run an Operating System (OS) with distributed file system (DFS) and other system and application software to self-form a distributed storage system with the mounted storage devices and with other similar intelligent storage systems.

By embedding an OS which runs DFS software in each of the hardware controller boards in the storage array enclosure, the storage array enclosure system in the example embodiment is able to self-form a distributed storage cluster with storage devices (such as hard disk drives (HDDs) or solid state drives (SSDs)) attached and with other similar intelligent storage array enclosure systems that are reachable through a network switch. Applications and servers are able to perform data transfer directly to the storage devices attached to the ISAE via the network switch without the need for storage servers.

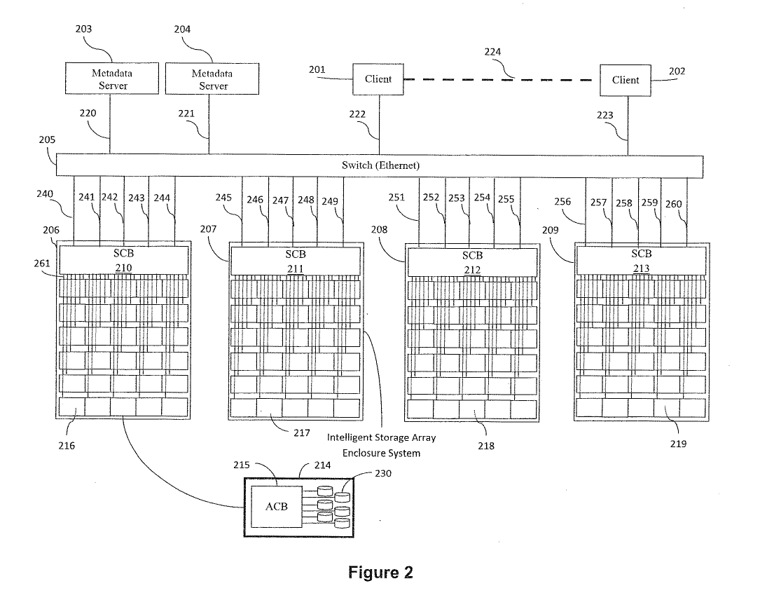

FIG. 2 shows a block diagram illustrating a distributed active storage architecture according to an example embodiment. Referring to FIG. 2, each active storage array (also referred to as Intelligent Storage Array Enclosure (ISAE)) 206, 207, 208, 209 in the example embodiments contains multiple Active Storage Unit (ASU) 216, 217, 218, 219 and one or more Switch Controller Boards (SCB) 210, 211, 212, 213. SCBs 210, 211, 212, 213 connect all ASUs 216, 217, 218, 219 inside together and provide connections for external clients 201, 202 or Metadata Servers 203, 204 to access Storage Devices 230 inside respective ISAEs. This can be implemented by way of an Ethernet switch 205 through which connections 220, 221 with metadata servers 203, 204, connections 222, 223 with clients 201, 204, 224 and connections 240-244, 245-249, 251-255 and 256-260 with the ISAE 206, 207, 208 and 209, can be effected. The SCB 210, 211, 212, 213 are communicatively coupled to the ASUs 214, 216, 217, 218, 219 by way on connections 261. Storage Devices 230 can be hard disk drives (HDDs), hybrid hard disk drives, solid state drives (SSDs), hybrid solid state drives, or any form of storage media with large storage capacity. Each ASU 214 contains an Active Controller Board (ACB) 215 and multiple Storage Devices 230. With the rapid advancement of central processing unit (CPU) and non-volatile memory, such controller boards can be feasibly implemented. The controller board is configured for storage and data processing functionalities for cost effectiveness and energy efficiency. In an embodiment, each ACB 215 drives 6 units of 2.5″ HDD with two 10 GbE interfaces and each ISAE contains 30 units of ASU. That gives out a total of 180 units of HDDs in one ISAE.

In this architecture, clients 201, 202, 224 perform data transfer directly to the intelligent storage array enclosure systems 206, 207, 208, 209 without the need for storage servers. The intelligent ACB 215 has the computational and memory resources to perform many of the tasks that are found in storage servers including processing and interpreting object and file transfer protocols into actual data transfer to or from the attached storage devices 230, and enable other smart file system and data manipulation functionalities for managing the storage devices 230. The ACBs 215 include DFS software to provide the formation and maintenance of distributed storage cluster with other ACBs 215 within the ISAE and across other ISAEs that are reachable within the switch network. The removal of storage servers by placing the file system and other system functionalities into ISAE 206, 207, 208, 209 can improve the cost efficiency in scaling storage resources with the reduction in equipment costing, energy consumption, space and server maintenance towards greener and sustainable data centers.

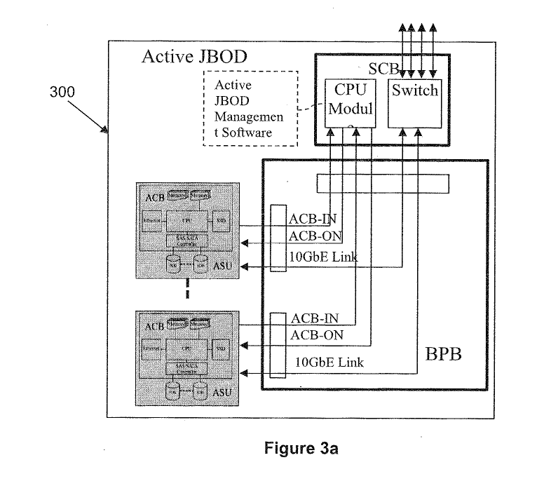

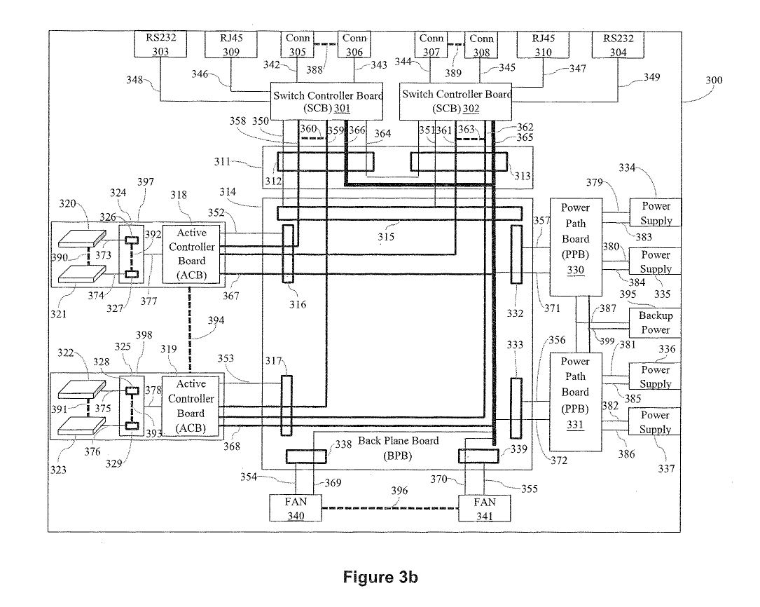

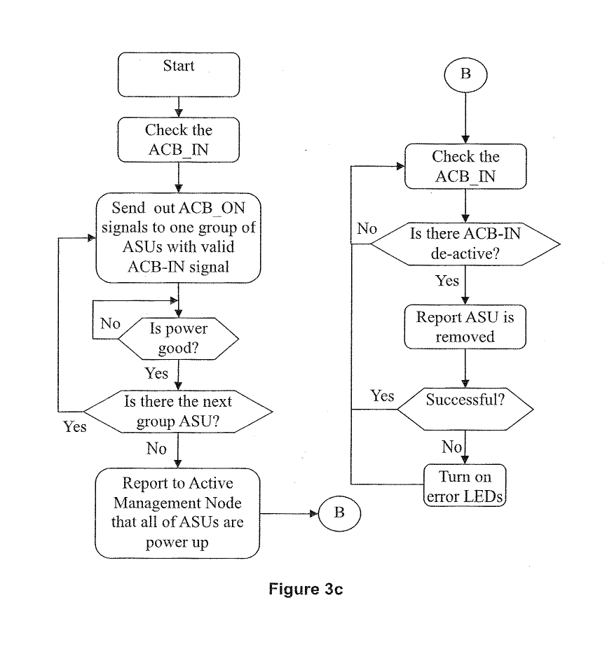

FIG. 3a shows a logic-level block diagram illustrating an active storage array 300 according to an example embodiment. FIG. 3b shows an example hardware-level block diagram of the active storage array 300 of FIG. 3a.

The active storage array 300 includes at least one, typically multiple, Active Storage Unit (ASU) 397, 398, 394, one or more Switch Controller Boards (SCB) 301, 302, a plurality of Power Supplies 334, 335, 336, 337, one Backup Power Supply 395, and multiple fans 340, 341. ASU 397, 398, 394 are hot-pluggable and plugged on to sockets 316, 317 on a Back Plane Board (BPB) 314. SCB 301, 302 are also hot-pluggable and plugged on to socket 312, 313 of Switch Interface Board (SIB) 311, while SIB 311 is mounted onto socket 315 on BPB 314. Power Supplies 334, 335, 336, 337 are hot-pluggable and plugged on to respective Power Path Boards (PPBs) 330, 331. PPBs 330, 331 are mounted onto socket 332, 333 on BPB 314. Fans 340, 341, 396 are hot-pluggable and plugged into sockets 338, 339 on BPB 314.

Network Connectors 305, 306, 307, 308, 388, 389 connect the active storage array 300 to an external network, and are coupled to the SCBs 301, 302 via connections 342, 343, 344, 345. Connectors 303, 304, 309 310 are coupled to the SCBs 301, 302 via connections 348, 349, 346, 347 respectively. The connectors 309, 310 maybe of RJ45 or other physical Ethernet connection to provide debug channel for internal switches while RS232 connectors 303, 304 provide access interface to Management Microprocessor.

Each ASU 397, 398, 394 provides two groups of network signals—signals 358/361 for ASU 397 and signals 359/362 for ASU 398. One group of network signals (signal 358 from ASU 397, signal 359 from ASU 398) is routed to one SCB 301 via BPB 314 and SIB 311 while the other group (signal 361 from ASU 397, signal 362 from ASU 398) is routed to the other SCB 302. This implementation provides hardware redundancy for network routing paths or adds more network connections. It would be appreciated that the number of SCBs may vary from one to a multiple depending on e.g. the number of ASUs and number of network connections. Connection 364 connects SCB 301, 302 together via a network connection e.g. 1 GbE/2.5 GbE/10 GbE/40 GbE/100 GbE/InfiniBand/Fiber Channel/QSGMII/SGMII.

ASUs 397, 398, 394 receive power from Power Supplies 334, 335, 336, 337 and backup power supply 395 via connections 352, 353. SCBs 301, 302 receive power from Power Supplies 334, 335, 336, 337 and backup power supply 395 via connections 350, 351. Fans 340, 341, 396 receive power from Power Supplies 334, 335, 336, 337 and backup power supply 395 via connections 354, 355 while SCB 301, 302 control fan speed via connections 369, 370.

Power signal bus 371 passes Power signal bus 383 (which includes Power Good Signal) from Power Supply 334 and Power signal bus 384 (which includes Power Good Signal) from Power Supply 335, and backup power signal bus 399 (which includes Power Good Signal) to Management Bus 365, 366 via the Connector 332. Power signal bus 372 passes Power signal bus 385 (which includes Power Good Signal) from Power Supply 336 and Power signal bus 386 (which includes Power Good Signal) from Power Supply 337, and backup power signal bus 399 (which includes Power Good Signal) to Management Bus 365, 366 via the Connector 333. Also shown in FIG. 3 are connections 379, 380, 381, 382 between the Power Supplies 334, 335, 336, 337 and PPBs 330, 331; connection 387 between the back-up Power Supply 395 and the PPBs 330, 331; and connections 356, 357 between PPBs 330, 331 and sockets 332, 333.

As described in further detail with reference to FIG. 3c, during operation, one of SCBs 301, 302 sends out an ACB-ON signal to ASU 397, 398, 394 to turn on power via Management Bus 365, 366 and ASU Management Bus 367, 368. SCB 301 or 302 turns on ASU 397, 398, 394 in phases to reduce the requirement of peak power from Power Supplies 334, 335, 336, 337.

Each ASU 397, 398, 394 includes one Active Controller Board (ACB) 318, 319, one Storage Interface Board (SIB) 324, 325 and multiple Storage Devices 320, 321, 322, 323, 390, 391. Storage Devices 320, 321, 322, 323, 390, 391 can be hard disk drives (HDDs), hybrid hard disk drives (Hybrid HDDs), solid state drives (SSDs), hybrid solid state drives (Hybrid SSDs), or any form of storage media with large storage capacity. Each of Storage Devices 320, 321, 322, 323, 390, 391 is inserted on to Media Connectors 326, 327, 328, 329, 392, 393 on SIB 324, 325. The Media Signals 373, 374, 375, 376 from Storage Devices 320, 321, 322, 323 are aggregated to Collection Connection 377, 378 which are routed to ACB 318, 319. As described, the ACB, storage devices and aggregated connections are contained in the ASU 397, 398, 394. Multiple ASUs are linked by SCB 301, 302. Storage Media 320, 321, 390, 322, 323, 391 are accessed via network connectors 358, 359, 361, 362, 360, 363 on SCB 301, 302. ASU 397, 398, 394, SCB 301, 302 and Power Supplies 334, 335, 336, 337 are hot-pluggable. BPB 314, PPB 330, 331 and SIB 311 are used for docking and passing all the signals and power sources. Data redundancy and replication are implemented between ASU by software, to create simple and reliable storage architecture.

One embodiment of ASU 397, 398, 394 contains 6 pieces of 2.5″ HDDs while one embodiment of the active storage array 300 contains 30 pieces of ASU 397, 398, 394. That provides a total of 180 pieces of 2.5″ HDD for one active storage array. The number of HDDs per ASU and the number of ASUs per storage array may vary as would be appreciated by persons skilled in the art.

With reference to FIGS. 3a and 3c, example diagnostic operations of the active storage array 300 are described. The active storage array 300 in the example embodiment is configured to power on the active storage units in phases. For example, during a powering up operation, first, the CPU module of the SCB checks the ACB-IN signals from the connected ASUs. Next, the CPU module of the SCB sends out the ACB_ON signals to one group of ASUs with a valid ACB-IN signal to power on this group of ASUs, and checks whether the power supply to this group of ASUs is good. If the result is negative, the check is repeated. If the result is positive, the CPU module proceeds to check whether there is a next group of ASUs. If there is another group of ASUs, the CPU module repeats the step of powering on and checking the power supply for that group of ASUs. Whether there is no further group of ASUs with valid ACB-IN signal, the CPU module reports that all of the ASUs are powered up.

In another self-diagnostic operation, for example, during normal working of the active storage array, the CPU module of the SCB again checks the ACB-IN signals from the connected ASUs. If there is an ACB-IN signal that is deactivated, the CPU module reports that the ASU providing that signal is removed. If there is no deactivated ACB-IN signal, or the reporting is successful, the CPU module continues monitoring, e.g. on a scheduled interval basis. On the other hand, if the reporting is not successful, the CPU module turns on the error LEDs inform users of the error.

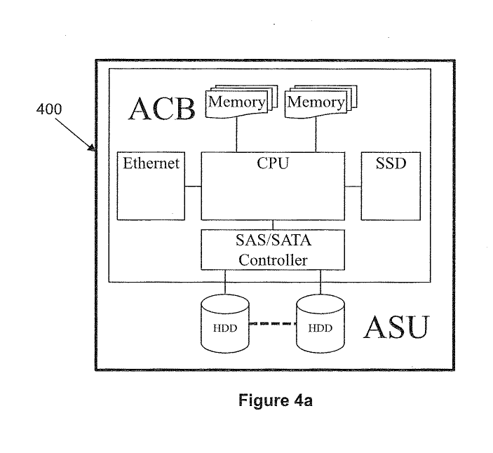

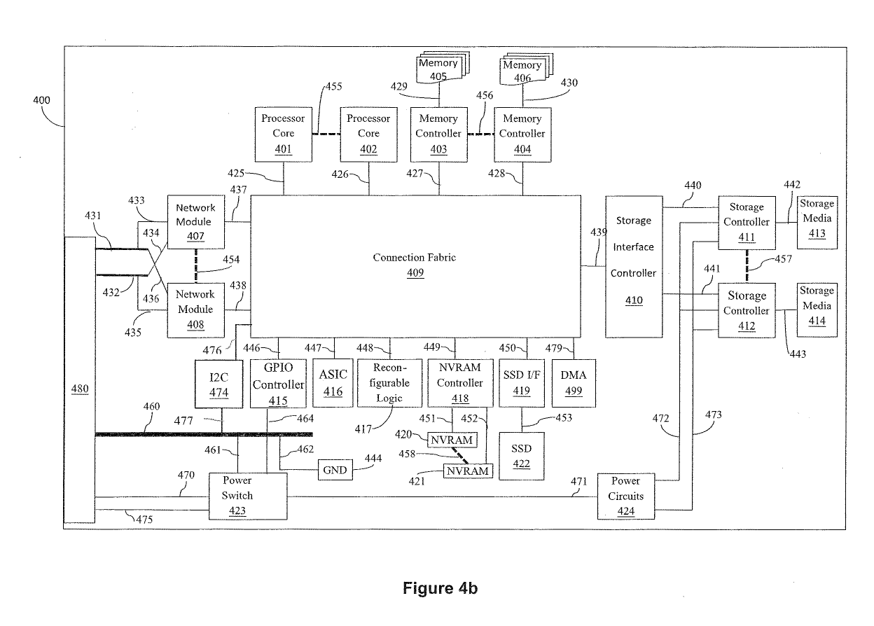

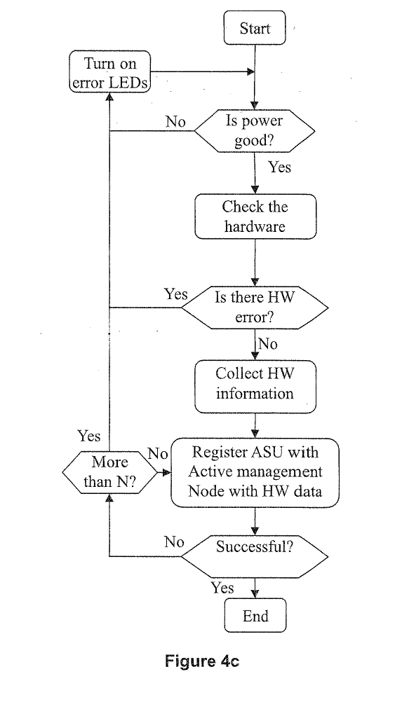

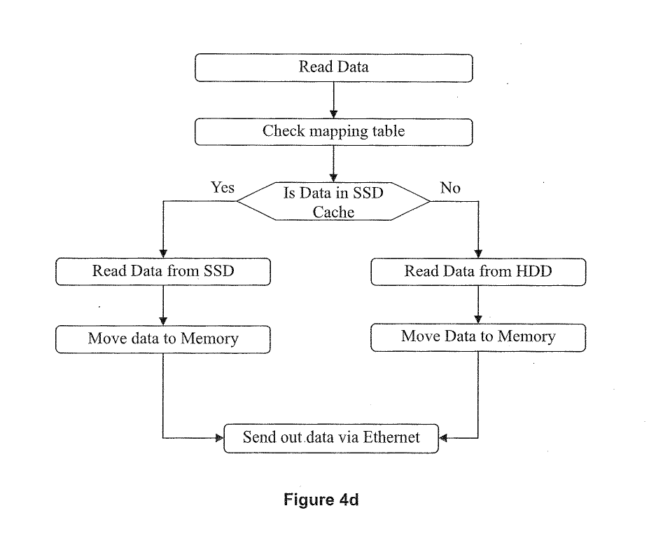

FIG. 4a shows a logic-level block diagram of an active storage unit (ASU) 400 according to an example embodiment. FIG. 4b shows an example hardware-level block diagram of the active storage unit 400 of FIG. 4a.

The ASU includes an active control board (ACB) communicatively coupled to a plurality of storage drives. As illustrated in FIG. 4b, the ACB in the example embodiment has one or more processor cores 401, 402, 455 with at least one memory controller 403, 404, 456. Memory controller 403, 404, 456 have working memory modules 405, 406 connected thereto via connections 429, 430. The ACB also includes multiple network modules 407, 408, 454 for network connection, e.g. 1 GbE/2.5 GbE/10 GbE/40 GbE/100 GbE/InfiniBand/Fiber/QSGMII/SGMII Channel, with network bus 431, 432 via connections 433, 434, 435, 436, and storage interface controller 410 provides an interface between Connection Fabric 409 and storage controller 411, 412, 457 via connection 439. Storage controller 411, 412, 457 manages storage devices 413, 414 such as 3.5″ HDD, 2.5″ HDD and SSD. For example, storage devices 413, 414 are connected via connections 442, 443 to storage controllers 411, 412, 457 which are then connected to the storage interface controller 410 via connections 440, 441.

The ACB further includes an interface 419, such as a SATA/PCI-E, NVMe interface, to SSD 422 via connection 453. The ACB also includes a non-volatile memory (NVM) controller module 418 that is connected to NVM 420, 421, 458, such as SLC/MLC/STT-MRAM, RRAM, via connections 451, 452. A reconfigurable logic circuit 417 provides on-field and on-time programmable offloading and supports customized usage. The ACB with the processing engine and other memory resources provides for an OS and system stacks to run DFS and other software. The software collectively provides the intelligent data storage and computing services, and manages the local storage and other hardware resources on-board or connected through its network interface.

The processor cores 401, 402, 455 are connected to memory controller via dedicated channels 425, 426, 427, 428. Network modules 407, 408, 454 Storage interface controller 410, direct memory access (DMA) module 499, SSD interface 419, NVM controller 418, reconfiguration logic circuit 417, ASIC 416 and GPIO controller 415 have direct channels 437, 438, 439, 479, 450, 449, 448, 447, 446 to the memory controller 403, 404, 456 by way of a connection fabric 409. The memory controller 403, 404, 456 is capable of supporting low latency NVRAM like STT-MRAM, MRAM or RRAM. NVRAM controller 418 is capable of supporting RRAM or SLC/MLC flash. SSD interface 419 connects SSD. NVMs provide hybrid and non-volatile cache for the storage devices 413, 414.

In the example embodiment, in case of the volatile memory, a power failure triggers the ACB to write back important data in the volatile memory to NVM 420, 421, 458 or SSD 422 or storage drives 413, 414 to provide protection of data. Also, the ACB includes power switch circuits 423 to allow the CPU module of the SCB (FIGS. 3a, 3b) to turn on multiple ASUs of the active storage array in phases to reduce the requirement for peak current from the power supplies. ACB informs chassis manager it is in by pull low the signal of ACB-IN. The CPU module of the SCB asserts ACB-ON 461 and Power OK signal 464 to the Power Switch 423, the Power Switch 423 only connects the connection 471 and the connection 470. The connection 470 is connected to power output of power supplies via connector 480. Management bus 460 manages the connections to connector 480. Power supply is provided to the storage controllers 411, 412, 457 via power circuits 424 and connections 472, 273.

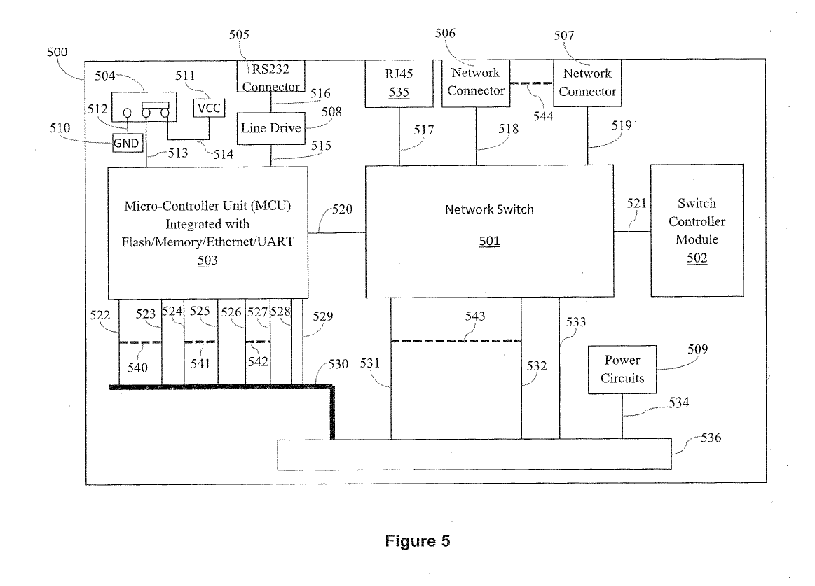

When the CPU module de-asserts Power OK signal 464, the Power Switch 423 only connects the connection 471 to the connection 475 which is the power source from back-up power supply. If Power OK signal 464 is deactivated, the software running on Processor Core 401, 402, 455 is triggered to backup key data to NVM 420, 421, 458 or SSD 422. ACB informs Management Microprocessor 503 (FIG. 5) that it is plugged in by pulling low the signal of ACB-IN 462 which is connected to GND 444 with voltage of 0V. Inter-Integrated Circuit (I²C) controller 474, which is connected to the processor cores 401, 402, 455 via connection 476, works as both master and slave modes to communicatively coupled between the processor cores 401, 402, 455 and the CPU module 503 (FIG. 5) of the SCB to exchange information.

FIG. 4c shows a flow chart illustrating a plug-and-play capability of the active storage unit 400 of FIG. 4a. In an example implementation, if the power signal is good, the next step is to check whether there is any hardware error. If there is no hardware error, the hardware information of the active storage unit 400 is collected and the active storage unit is registered with the active management node together with the hardware data. If the registration is not successful, the active storage unit 400 attempts to register again, and if the registration is still not successful after a predetermined N number of attempts, the error LEDs are turned on. Similarly, if the power signal is not good, or if there is a hardware error, the LEDs are turned on.

FIG. 4d shows a flow chart illustrating an example data transfer process in the active storage unit 400 of FIG. 4a. First, the data is read, then the mapping table is checked. Next, the active storage unit 400 checks whether the data is present in the cache (e.g. the NVM or SSD). If the data is in the cache, the data is read and moved to the memory before being sent out via the Ethernet connection. On the other hand, if the data is not present in the cache, the data is read from the storage devices (e.g. HDDs) and moved to the memory before being sent out via the Ethernet connection.

FIG. 5 shows a hardware-level block diagram of a switch control board (SCB) 500 according to an example embodiment. The SCB 500 includes a CPU or microcontroller unit 503 communicatively coupled to a network switch 501 and a switch controller module 502 communicatively coupled to the network switch 501. The SCB network switch 501 is configured to balance data throughput of internal ports 531, 532, 543, other switch port 533 and external ports 506, 507, 544. The switch controller module 502 manages the network switch 501, while the microcontroller unit 503 manages power on sequence, fan speed and other chassis management operations. Each SCB 500 is configured to support multiple ACBs and provide several Ethernet ports 506, 507, 544 for external connections. The SCB 500 also enables data to be moved between ACBs/drives without going through an external network, thereby reducing network congestion and improve network throughput. In one possible configuration, the SCB 500 can connect to 30 ACBs using a 10 Gigabit Ethernet (GbE) connection each and has 4×40 GbE ports as external connections. Using two or more SCBs in one active storage array can boost the reliability of the active storage array as redundancy is provided.

Chassis management microprocessor (i.e. microcontroller unit 503) is set to master or slave via jumper while the firmware is upgradable via Ethernet interface 520. Chassis manager software running in the microcontroller unit 503 can turn on each ACB in batch (i.e. in phases) by asserting the ACB_ON in a sequential order. The Ethernet links between SCBs can be trunked or aggregated into one single logical link to increase throughput between the SCBs. Additional SCBs can provide for higher number of ACBs and more external network port connections. Alternatively, multiple SCBs can also be consolidated into a single SCB with multiple Ethernet switch controllers on-board. The microcontroller unit 503 can be programmed via connector 505, connection 516, line drive 508 and connection 515. Also connected to the microcontroller unit 503 is a circuit including Vcc 511, GND 510, switch 504 and connections 512, 513, 514.

Connection 531, 532, 543 are network connections, e.g. 1 GbE/2.5 GbE/10 GbE/40 GbE/100 GbE/InfiniBand/Fiber/QSGMII/SGMII Channel which are connected to ACBs via connector 536 and BPB. Connection 533 connects two SCBs together via network connection. Power Circuits 509 gets power source via connection 534 and connector 536 from power supplies 334, 335, 336, 337 (FIG. 3b). Connections 522, 523, 540 are inputs from ACB-IN of ACBs via connector 536, SIB 311 (FIG. 3b and BPB 314 (FIG. 3b). Connections 524, 525, 541 are ACB-ON signals of output of MCU or CPU module 503 to turn on or off each ACB. Connections 526, 527, 542 include multiple GPIOs and I²C bus to control FAN, LEDs, buttons, power supplies. Connection 528 and connection 529 are power good signal inputs from power supplies 334, 335, 336, 337 (FIG. 3b).

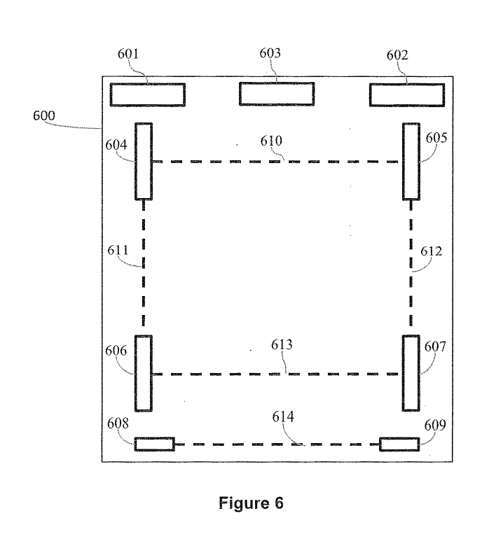

FIG. 6 shows a hardware-level block diagram of a back plane board (BPB) 600 according to an example embodiment. The BPB 600 supports hot-plug of ACB via connectors 604, 605, 606, 607, 610, 611, 612, 613, SCB via connectors 603 and power supply via connectors 601 and 602. The BPB 600 supplies power to ACB via connectors 604, 605, 606, 607, 610, 611, 612, 613 SCB via connectors 603 and fan via connectors 608 and 609. The BPB 600 also routes the signal traces between the connectors of ACBs to the connectors of SCB. Power is delivered to ACBs in the form of rows and a micro-controller 503 (FIG. 5) is used to enable the power to each row in sequence upon powering-up of the active storage array.

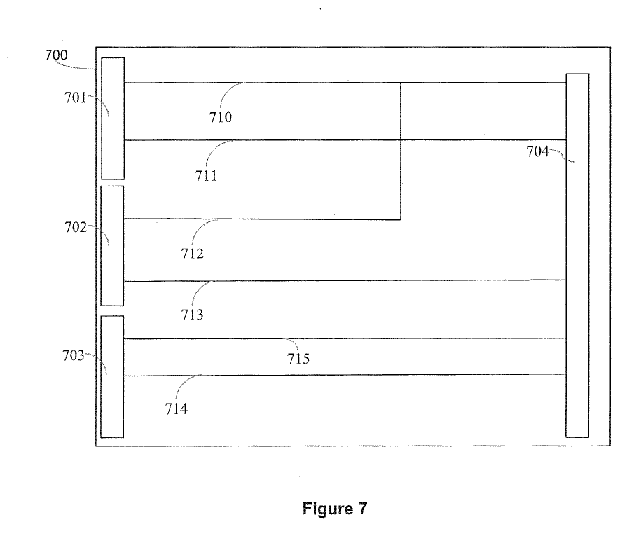

FIG. 7 shows a hardware-level block diagram of a power path board (PPB) 700 according to an example embodiment. The PPB 700 merges AC/DC power 710 from the connectors 701 and AC/DC power 712 from the connector 702 to the connector 704. The back-up power 714 from the connector 703 is also passed to the connectors 704. The power signal bus 711 from the connector 701 of the power supply and the power signal bus 713 from the connector 702 of AC/DC power supply are connected directly to the connector 704. The back-up power signal bus 715 from connector 703 is also passed to connector 704. The connector 704 is plugged into BPB 600 (FIG. 6).

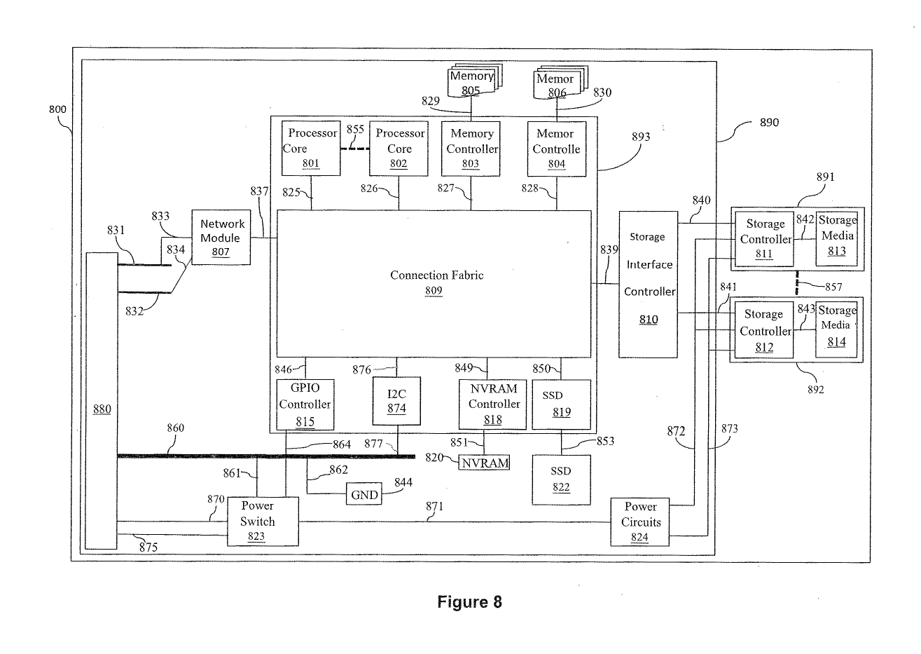

FIG. 8 shows a hardware-level block diagram of the active storage unit (ASU) 800 according to another example embodiment. In this embodiment, the ACB 890 comprises an off-the-shelf System on Chip (SOC) 893 and dual ports 10 GbE Network module 807. SOC 893 contains 2 to 8 processors 801, 802 and 855 and has one to two memory controllers 803, 804. The combination of the SoC includes 2 processor cores with one memory controller, dual 2 processor cores with one memory controller, dual four processors with one memory controller. The memory controllers 803, 804 connect DDR3 DRAM 805, 806 via up to 1600MT/s DDR3 memory bus 829, 830. The SoC 893 also includes two SATA 3.0 interfaces to serve as SSD interface (I/F) 819 and are connected to SSD 822. The SoC 893 further includes a SPI controller that serves as NVMRAM controller 818 to connect NVMRAM 820 via SPI interface 851 to store BIOS or uboot or boot up software. A connection fabric 809 is provided to facilitate communication between the various components.

A SAS/SATA PCI-E controller 810 is connected to the SoC 893 via PCI-E bus 839. The controller 810 can drive up to 16 pieces of SAS/SATA HDDs 891, 892, 857 which contain Storage Controller 811, 812 and Storage Media 813, 814 and both are linked by the Connection 842, 843.

The Network Module 807 is connected to the SoC 893 via PCI-E bus 837. The Network Module 807 contains two Ethernet ports and supports 1 GbE/2.5 GbE/10 GbE/QSGMII/SGMII and 802.3ap KX/KX4/KR specification. One port signal 833 is connected to SCB 301 (FIG. 3) via connections 831 while the other port signal 834 is connected to SCB 302 (FIG. 3) via connection 832.

During operation, if Power OK signal 864 from chassis management microprocessor 503 (FIG. 5) is deactivated, it will trigger SoC 893 via GPIO controller 815 in highest priority to interrupt processor cores 801, 802 to prepare to save important data to non-volatile memory like SSD 822 and stop unnecessary operations, and inform HDDs 891, 892 to go to lowest power mode and prepare to shut down. During the period of deactivation of Power OK signal 864, Back-up power supply 875 is configured to take over from AC/DC power supply 870 to supply power 870 to ASU 800 via Power Circuits 824 for a short while, through operation of Power Switch 823 and Power OK signal 864. Power Circuits 824 supplies one 12V supply 872 and 5V supply 873 to HDDs 891, 892.

ACB 890 also includes a Power Switch 823 that allows the ACB-ON signal 861 from the Management Microprocessor 503 (FIG. 5) to turn on the multiple ACBs in phases to reduce the requirement of peak current from the power supply. ACB informs Management Microprocessor 503 that it is plugged in by pulling low the signal of ACB-IN 862 which is connected to GND 844 with voltage of 0V.

Management bus 860 contains ACB-ON signal 861, Power OK signal 864, ACB-IN signal 862 and I²C bus 877. It is connected to Management Microprocessor 503 (FIG. 5). Inter-Integrated Circuit (I²C) controller 874, which is connected to the processor cores 801, 802, 855 via connection 876, works as both master and slave modes to communicatively couple between the processor cores 801, 802 and 855 and the CPU module 503 (FIG. 5) of the SCB to exchange information.

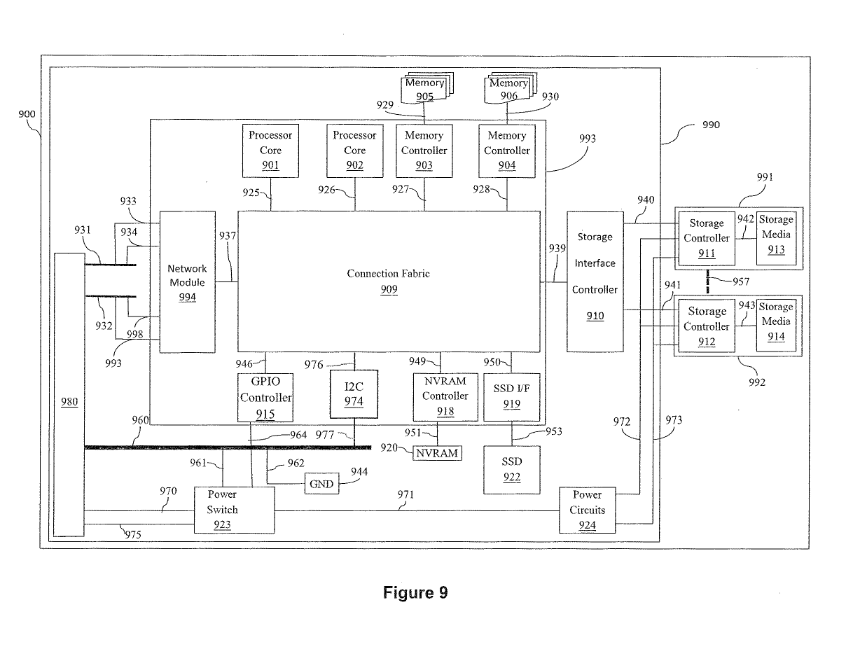

FIG. 9 shows a hardware-level block diagram of the active storage unit ASU 900 according to another example embodiment. In this embodiment, the ASU 900 includes an ACB 990 with off-shelf SoC 993 and 4×2.5GBASE Ethernet. This configuration can save cost and power by removing an external network chip but requires more Ethernet ports for connection to SCB via BPB.

SoC 993 includes 2 to 8 processor 925, 926 and has one to two memory controllers 903, 904. The combination of the SoC includes 2 processor cores with one memory controller, dual 2 processor cores with one memory controller, dual four processors with one memory controller. The memory controllers 903, 904 connect DDR3 DRAM 905, 906 via up to 1600MT/s DDR3 memory bus 929, 930. The SoC 993 includes two SATA 3.0 interfaces that serve as SSD I/F 919 and are connected to SSD 922. The SoC 993 also includes an SPI controller that serves as NVMRAM controller 918 to connect NVMRAM 920 via SPI interface 951 to store BIOS or uboot or boot up software.

A SAS/SATA PCI-E controller 910 is connected to the SoC 993 via PCI-E bus 939, and is configured to drive up to 16 pieces of SAS/SATA HDDs 991, 992 which contain Storage Controller 911, 912 and Storage Media 913, 914 and both are linked by Connection 942, 943.

A 4-port 2.5 GbE Network Module 994 is disposed inside the SoC 993. Two port signals 933, 934 are connected to SCB 301 (FIG. 3) via connection 931 while the other two port signals 993, 998 are connected to SCB 302 (FIG. 3) via connections 932.

If a Power OK signal 964 from the Management Microprocessor 503 (FIG. 5) is deactivated, it will trigger SoC 993 via GPIO controller 915 in highest priority to interrupt processor cores to prepare to save important data to non-volatile memory like SSD 922 and stop unnecessary operations, and to inform HDDs 991, 992 to go to the lowest power mode and prepare for shut-down. During the period of deactivation of Power OK signal 964, Back-up power supply connection 975 is configured to take over from AC/DC power supply connection 970 to supply power connection 970 to ASU 900 via Power Circuits 924 for a short while. Power Circuits 924 supply one 12V supply 972 and one 5V 973 supply to HDDs 991, 992.

ACB 990 includes Power Switch 923 that allows an ACB-ON signal 961 from the Management Microprocessor 503 to turn on multiple ACBs in phases to reduce the requirement of peak current from the power supply. For example, an ACB can inform the Management Microprocessor 503 that it is plugged in by pulling low the ACB-IN signal 962 which is connected to GND 944 with voltage of 0V.

Management bus 960 contains the ACB-ON signal 961, Power OK signal 964, ACB-IN signal 962 and I²C bus 977. It is connected to Management Microprocessor 503. I²C controller 974, which is connected to the processor cores 901, 902 via connection 976, works as both master and slave modes to communicatively couple between the processor cores 901, 902 and the CPU 503 (FIG. 5) module of the SCB to exchange information.

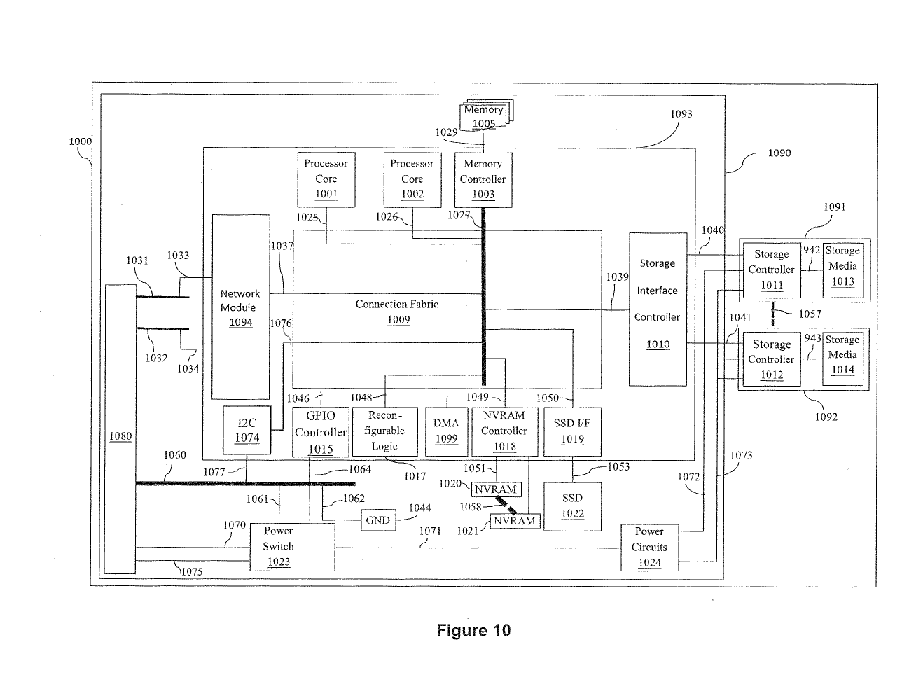

FIG. 10 shows a hardware-level block diagram of the active storage unit (ASU) 1000 according to another example embodiment. In this embodiment, the ASU 1000 includes an ACB 1090 in the form of a field-programmable gate array (FPGA) Chip 1093. The FPGA 1093 includes two ARM cores 1001, 1002 and one Memory Controller 1003 which is connected to DDR3 DRAM 1005. The FPGA 1093 also includes a two-port Network Module 1094 which can be configured as two ports of 1 GbE/2.5 GbE/10 GbE/40 GbE/100 GbE/InfiniBand/Fiber/QSGMII/SGMII or others. The FPGA further includes a programmable Storage Interface Controller 1010 which can be configured as multiple SATA Controllers if Storage Devices 1091, 1092 are SATA HDDs/SSDs, or as SAS Controllers if Storage Devices 1091, 1092, 1057 are SAS HDDs, or as NVMe Controllers if Storage Devices 1091, 1092 are NVMe storage devices. Other configurations are possible. In addition, the FPGA 1093 includes one SSD I/F 1019 which can be configured as SATA controller, NVMe controller or PCI-E or others to connected SSD 1022 via connections 1053. Also integrated is a NVRAM Controller 1018 to support SLC flash/MLC flash/STT-MRAM/MRAM/RRAM/other non-volatile memory chips 1020, 1021, 1058 via multiple IOs 1051. A reconfigurable logic circuit 1017 provides on-field and on-time programmable offloading and supports customized usage.

Here, Network Module 1094 is connected to Memory Controller 1003 via direct channel 1037, Storage Interface Controller 1010 is connected to Memory Controller 1003 via direct channel 1039, reconfigurable logic circuit 1017 is connected to Memory Controller 1003 via direct channel 1048, NVRAM Controller 1018 is connected to Memory Controller 1003 via direct channel 1049, SSD I/F 1019 is connected to Memory Controller 1003 via direct channel 1050. DMA 1099 controls the data movement among Memory Controller 1003, Network Module 1094, Storage Interface Controller 1010, reconfigurable logic circuit 1017, NVRAM Controller 1018 and SSD I/F 1019 by managing and switching Connection Fabric 1109.

The Network Module 1094 includes two ports and supports 1 GbE/2.5 GbE/10 GbE/40 GbE/100 GbE/InfiniBand/Fiber/QSGMII/SGMII and 802.3ap KX/KX4/KR specification. One port signal 1033 is connected to SCB 301 (FIG. 3) via connections 1031 while the other port signal 1034 is connected to SCB 302 (FIG. 3) via connection 1032.

If a Power OK Signal 1064 from Management Microprocessor 503 (FIG. 5) is deactivated, it triggers FPGA 1093 via GPIO controller 1015 in highest priority to interrupt processor cores 1001, 1002 to save important data to non-volatile memory like SSD 1022 or NVRAMs 1020, 1021, 1058 and stop unnecessary operations, and inform Storage Devices 1091, 1092, 1057 to go to the lowest power mode and prepare to shut down. During the period of deactivation of Power OK signal 1064, Back-up power supply connection 1075 is configured to take over from AC/DC power supply connection 1070 to supply power connection 1070 to ASU 1000 via Power Circuits 1024 for a short while. Power Circuits 1024 is configured supply two different power supplies 1072, 1073 to Storage Devices 1091, 1092.

ACB 1090 is defined with a Power Switch 1023 that allows an ACB-ON 1061 signal from Management Microprocessor 503 to turn on multiple ACBs 1090 in phases to reduce the requirement of peak current for the power supply. For example, the ACB 1090 informs Management Microprocessor 503 that it is plugged in by pulling low the ACB-IN signal 1062 which is connected to GND 1044 with voltage of 0 Volt. Management bus 1060 contains ACB-ON signal 1061, Power OK signal 1064, ACB-IN 1062 and 120 bus 1077, and is connected to Management Microprocessor 503. I²C controller 1074, which is connected to processor cores 1001, 1002 via connection 1076, works as both master and slave modes to communicatively couple between the processor cores 1001-1002 and the CPU module 503 (FIG. 5) of the SCB to exchange information.

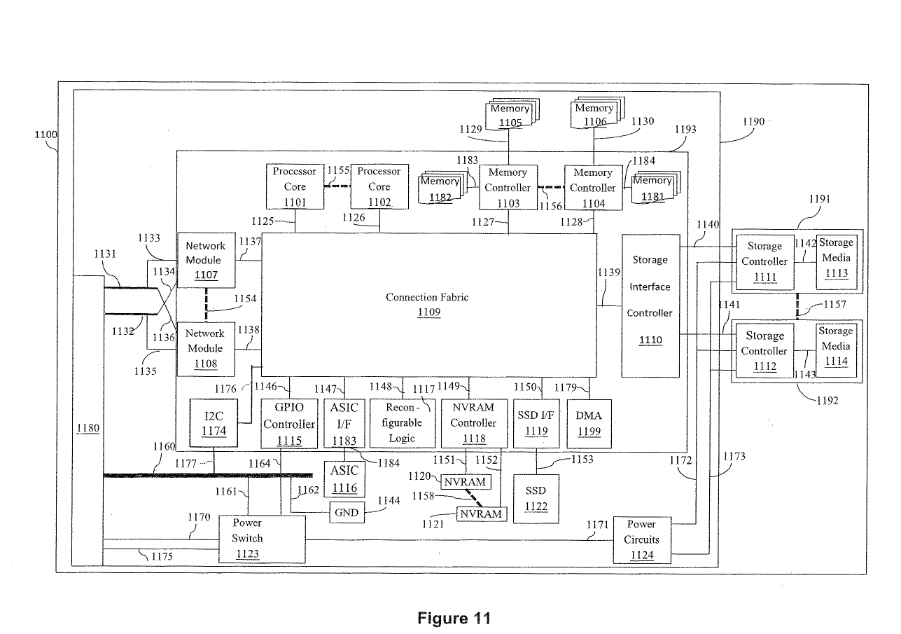

FIG. 11 shows a hardware-level block diagram of the active storage unit (ASU) 1100 according to another example embodiment. In this embodiment, the ASU 1100 includes an ACB with Customized SoC 1193. The SoC 1193 includes two or more 64-bit ARM processor cores 1155 or other low-power 64-bit processor cores 1101, 1102, two or more memory controller 1103, 1104, 1156, one or more Network Modules 1107, 1108, 1154, one Storage Interface Controller 1110, a NVM controller 1118, a SSD I/F 1119, an ASIC I/F 1183 and reconfigurable logic circuit 1117.

Each Processor Core 1101, 1102, 1155 is connected to Memory Controllers 1103, 1104, 1156 via a direct channel 1125, 1126 with less than 100 ns latency. Each Memory Controller 1103 or 1104 or 1156 is also connected to two banks of Memory 1105 and 1182, 1106 and 1181. One bank of Memory 1182 or 1181 is connected to Memory Controller 1103 or 1104 via connection 1183, 1184 and embedded inside SoC 1193. The other bank of Memory 1105, 1106 is optional and mounted on ACB 1190. Memory Controllers 1103, 1104, 1156 is capable of supporting DRR3 DRAM/DDR4 DRAM/STT-MRAM/RRAM/SRAM/MRAM.

Each Network Module 1107, 1108, 1154 contains two ports 1133 and 1134, 1135 and 1136 which supports 1 GbE/2.5 GbE/10 GbE/40 GbE/100 GbE/InfiniBand/Fiber/QSGMII/SGMII and 802.3ap KX/KX4/KR specification. Signals 1133, 1136 of one port are connected to SCB 301 (FIG. 3) via connections 1131 while signals 1134, 1135 of the other port are connected to SCB 302 (FIG. 3) via connection 1132. Network Modules 1107, 1108, 1154 are connected to Memory Controllers 1103, 1104, 1156 via direct channels 1137, 1138. Storage Interface Controller 1110 is connected to Memory Controllers 1103, 1104 and 1156 via direct channel 1139 and further connected to multiple types of Storage Devices 1191, 1192 and 1157 which can be SAS HDDs with all the form factors, SATA HDDs with all the form factors, SSDs with interfaces of SATA, SAS, NVMe, PCI-E and all the form factors.

SSD I/F 1119 is connected to Memory Controllers 1103, 1104 and 1156 via direct channel 1150 and further connected to multiple types of SSD 1122 with interfaces of SATA, SAS, NVMe, PCI-E and all the form factors. NVRAM Controller 1118 is connected to Memory Controllers 1103, 1104 and 1156 via direct channel 1149 and further connected to NVRAMs 1120, 1121 and 1158 which can be SLC Flash/MLC flash/RRAM. ASIC I/F 1116 is connected to Memory Controllers 1103, 1104 and 1156 via direct channel 1147 and further connected ASIC 1116 which is the chipset from off-the-shelf or customized integrated circuits via connections 1184 which can be PCI-E, Rocket IO, Hypertransport and others.

Further, reconfigurable logic circuit 1117 is connected to Memory Controllers 1103, 1104 and 1156 via direct channel 1148. The logic circuits can be programmed via connection fabric 1109 by software running on processor cores 1101, 1102 and 1155. Users can add in and change the functions of the reconfigurable logic circuit 1117 to support various features on-the-fly.

DMA 1199 controls the data movement among Memory Controllers 1103, 1104 and 1156, Network Module 1107, 1108 and 1154, Storage Interface Controller 1110, reconfigurable logic circuit 1117, NVRAM Controller 1118 and SSD I/F 1119 by managing and switching the Connection Fabric 1109 via connection 1179.

During operation of the ASU 1100, if a Power OK signal 1164 from Management Microprocessor 503 (FIG. 5) is deactivated, it triggers SoC 1193 via GPIO controller 1115 in highest priority to interrupt processor cores 1101, 1102 and 1155 to save important data to non-volatile memory like SSD 1122 or NVRAMs 1120, 1121 and 1158 and stop unnecessary operations, and inform Storage Devices 1191, 1192 to go to the lowest power mode and prepare to shut down. During the period of deactivation of the Power OK signal 1164, Back-up power supply connection 1175 is configured to take over from AC/DC power supply connection 1170 to supply power connection 1170 to ASU 1100 via Power Circuits 1124 for a short while. Power Circuits 1124 supplies two different power supplies 1172, 1173 to Storage Devices 1191, 1192.

ACB 1190 includes a Power Switch 1123 which allows an ACB-ON signal 1161 from the Management Microprocessor 503 to turn on ASU 1100 in phases to reduce the requirement of peak current from the power supply. For example, the ACB 1190 informs the Management Microprocessor 503 that it is plugged in by pulling low the ACB-IN signal 1162 which is connected to GND 1144 with voltage of 0V.

Management bus 1160 contains the ACB-ON signal 1161, Power OK Signal 1164, ACB-IN A signal 1162, and 120 bus 1177 and is connected to Management Microprocessor 503. I²C controller 1174, which is connected to the processor cores 1101, 1102, 1155 via connection 1176, works as both master and slave modes to communicatively couple between the processor cores 1101-1102, 1155 and the CPU module 503 (FIG. 5) of the SCB to exchange information.

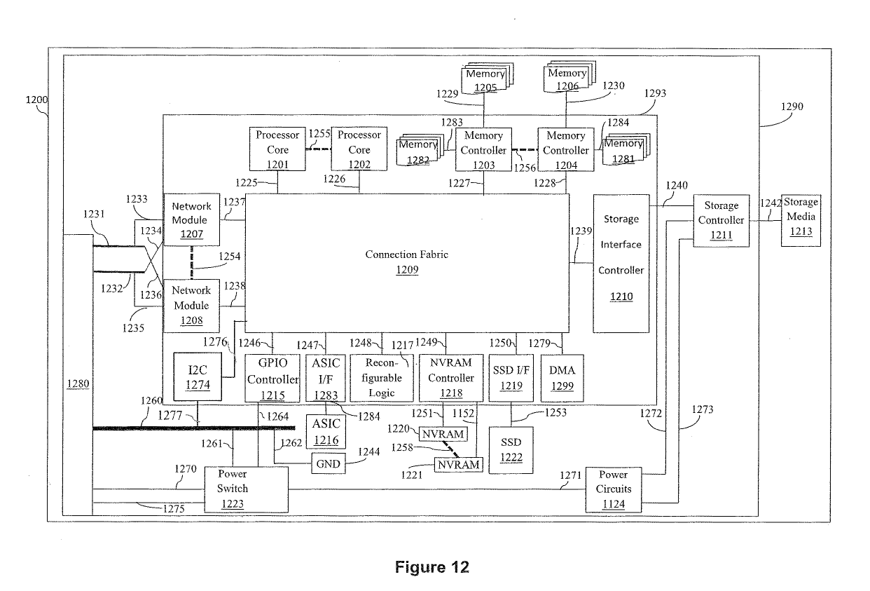

FIG. 12 shows a hardware-level block diagram of the active storage unit (ASU) 1200 according to yet another example embodiment. In this embodiment, the ASU 1200 comprises an ACB 1290 on Storage Media. Both SoC 1293 and Storage Controller 1211 are mounted on the ACB 1290.

The SoC 1293 includes two or more multiple 64-bit ARM processor cores 1255 or other low power 64-bit processor cores 1201, 1202, two or more memory controller 1203, 1204, 1256, one or more Network Modules 1207, 1208, 1254, one Storage Interface Controller 1210, a NVM controller 1218, an SSD I/F 1219, an ASIC I/F 1283 and a reconfigurable logic circuit 1217.

Each Processor Core 1201 or 1202 or 1255 is connected to Memory Controllers 1203, 1204 or more 1256 via direct channel 1225, 1226 with less than 100 ns latency.

Each Memory Controller 1203 or 1204 or 1256 is connected to two banks of Memory 1205 and 1282, 1206 and 1281. One bank of Memory 1282 or 1281 is connected to Memory Controller 1203 or 1204 via connection 1283, 1284 and embedded inside SoC 1293. The other bank of Memory 1205, 1206 is optional and mounted on ACB 1290. Memory Controllers 1203, 1204, 1256 is capable of supporting DRR3 DRAM/DDR4 DRAM/STT-MRAM/RRAM/SRAM/MRAM.

Each Network Module 1207, 1208 or 1254 contains two ports 1233 and 1234, 1235 and 1236 which supports 1 GbE/2.5 GbE/10 GbE/40 GbE/100 GbE/InfiniBand/Fiber/QSGMII/SGMII and 802.3ap KX/KX4/KR specification. Signals 1233, 1236 of one port are connected to SCB 301 (FIG. 3) via connections 1231 while signals 1234, 1235 of the other port are connected to SCB 302 (FIG. 3) via connection 1232. Network Modules 1207, 1208 and 1254 are connected to Memory Controllers 1203, 1204 and 1256 via direct channels 1237, 1238.

Storage Interface Controller 1210 is connected to Memory Controllers 1203, 1204 and 1256 via direct channel 1239 and is further connected to multiple types of Storage Devices 1291 which can be SAS HDDs with all the form factors, SATA HDDs with all the form factors, SSDs with interfaces of SATA, SAS, NVMe, PCI-E and all the form factors.

SSD I/F 1219 is connected to Memory Controllers 1203, 1204 and 1256 via direct channel 1259 and is further connected to multiple types of SSD 1222 with interfaces of SATA, SAS, NVMe, PCI-E and all the form factors. NVRAM Controller 1218 is connected to Memory Controllers 1203, 1204 and 1256 via direct channel 1249 and is further connected to NVRAMs 1220, 1221 and 1258 which can be SLC Flash/MLC flash/RRAM.

ASIC I/F 1216 is connected to Memory Controllers 1203, 1204 and 1256 via direct channel 1247 and is further connected ASIC 126 which is the chipset from off-the-shelf or customized integrate circuits via connections 1284 which can be PCI-E, Rocket 10, Hypertransport and others.

Reconfigurable logic circuit 1217 is connected to Memory Controllers 1203, 1204 and 1256 via direct channel 1248. The logic circuits can be programmed via connection fabric 1209 by software running on processor cores 1201, 1202 and 1255. Users can add in and change the functions of the reconfigurable logic circuit 1217 to support the various features on-the-fly.

DMA 1299 controls the data movement among Memory Controllers 1203, 1204 and 1256, Network Module 1207, 1208 and 1254, Storage Interface Controller 1210, reconfigurable logic circuit 1217, NVRAM Controller 1218 and SSD I/F 1219 by managing and switching Connection Fabric 1209 via connection 1279.

During operation of the ASU 1200, if a Power OK signal 1264 from Management Microprocessor 503 (FIG. 5) is deactivated, it triggers SoC 1293 via GPIO controller 1215 in the highest priority to interrupt processor cores 1201, 1202 and 1255 to save important data to non-volatile memory like SSD 1222 or NVRAMs 1220, 1221 and 1258 and stop unnecessary operations, and inform storage devices 1291 to go to lowest power mode and prepare to shut down. During the period of deactivation of the Power OK signal 1264, Back-up power supply connection 1275 is configured to take over from AC/DC power supply connection 1270 to supply power connection 1270 to ASU 1200 via Power Circuits 1224 for a short while. The Power Circuits 1224 can supply two different power signals 1172, 1173 to Storage Controller 1211.

ACB 1290 further includes a Power Switch 1223 which allows an ACB-ON signal 1261 from the Management Microprocessor 503 to turn on ASU 1200 in phases to reduce the requirement of peak current from the power supply. For example, ACB 1290 informs the Management Microprocessor 503 that it is plugged in by pulling low the ACB-IN signal 1262 which is connected to GND 1244 with voltage of 0V. Management bus 1260 includes ACB-ON 1261 signal, Power OK signal 1264 and ACB-IN 1262 signal and I²C bus 1277 and is connected to Management Microprocessor 503. I²C controller 1274, which is connected to the processor cores 1201, 1202, 1255 via connection 1276, works as both master and slave modes to communicatively coupled between the processor cores 1201-1202, 1255 and the CPU module 503 (FIG. 5) of the SCB to exchange information.

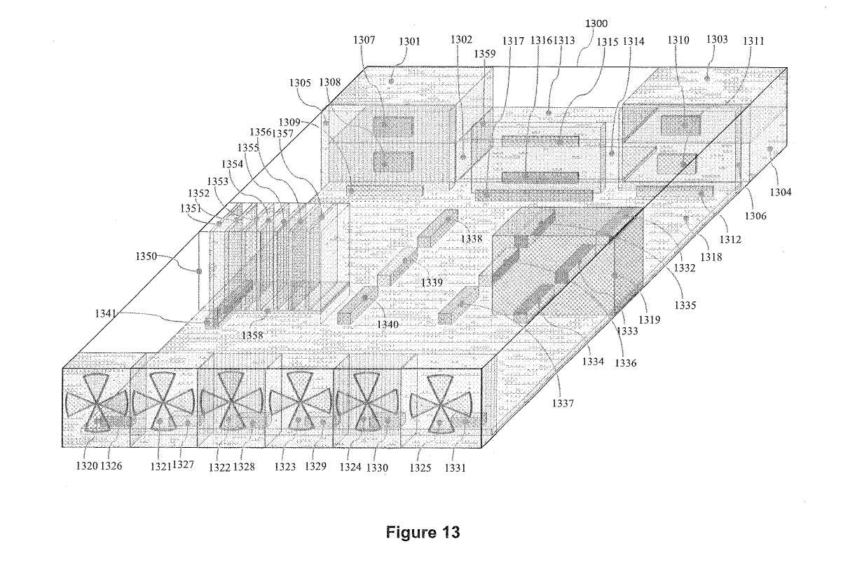

FIG. 13 shows a block diagram illustrating a physical layout of the active storage array 1300 according to an example embodiment. In this layout, Power Supplies 1301, 1302 are located at the left rear side of active storage array 1300 and plugged on to connectors 1307, 1308 on the Power Path Board (PBP) 1305 which is plugged on to connector 1309 on the Back Plane Board (BPB) 1318. Power Supplies 1303, 1303 are located at the right rear side of the active storage array 1300 and plugged on to connectors 1310, 1311 on the PBP 1306 which is plugged on to connector 1312 on the BPB 1318.

Two Switch Controller Boards 1313, 1314 are plugged into the active storage array 1300 horizontally to connectors 1315, 1316 on the Switch Interface Board (SIB) 1359 which is plugged on to connector 1317 on BPB 1318. Active Controller Units (ASU) 1350, 1319 are plugged on to connectors 1341, 1332, 1333, 1334, 1335, 1336, 1337, 1338, 1339, 1340 on the BPB 1318. Each ASU 1350, 1319 includes multiple Storage Devices 1352, 1353, 1354, 1355, 1356, 1357 and one Active Controller Board ACB 1351. Storage Devices 1352, 1353, 1354, 1355, 1356, 1357 are plugged on to Interface Daughter Board (IDB) 1358 which is connected to ACB 1351 via a flexible cable.

In addition, fans 1320, 1321, 1322, 1323, 1324, 1325 are connected to connectors 1326, 1327, 1328, 1329, 1330, 1331 on the BPB 1318.

This embodiment of ASU 1350, 1319 contains 6 pieces of 2.5″ HDD while one of embodiment of the active storage array contains 30 pieces of ASU. That provides a total of 180 pieces of 2.5″ HDDs for one active storage array 1300. Network signals are routed to Switch Controller Boards 1313, 1314.

The active storage unit and active storage array as described in the example embodiments can be implemented using various hardware platforms, such as off-the-shelf Soc, customised Soc, FPGA, etc. The plug-and-play capability allows the active storage array to be scalable while the power management capability allows the various units to be switched on in phases while preventing data loss in the event of a power disruption. Also, the reconfiguration logic allows each unit to be programmed on-the-fly, thus reducing down time.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An active storage unit comprising:
a plurality of storage devices; and
an active control board comprising a processor, at least one internal memory module communicatively coupled to the processor, a non-volatile memory (NVM) module communicatively coupled to the processor, and a reconfigurable logic circuit communicatively coupled to the processor for programming the active storage unit on-the-fly,
wherein the plurality of storage devices are communicatively coupled to the active control board, and wherein the active control board further comprises a media controller communicatively coupled to the processor and the plurality of storage devices for enabling the processor to control access to the plurality of storage devices, and wherein functions and features of the active storage unit can be changed on-the-fly.

2. The active storage unit as claimed in claim 1, wherein the non-volatile memory module of the active control board is a block-based NVM module and is configured to provide a cache for the block-based data stored in the plurality of storage devices.

3. The active storage unit as claimed in claim 2, wherein the processor is configured to write volatile data in the at least one internal memory module to the non-volatile memory module in an event of a power disruption.

4. The active storage unit as claimed in claim 3, further comprising a back-up power supply configured to provide emergency power for enough time to the active storage unit for the processor to write the volatile data in the at least one internal memory module to the non-volatile memory module in the event of a power disruption.

5. The active storage unit as claimed in claim 2, wherein the block-based non-volatile memory module comprises a solid state drive for storing block-based data.

6. The active storage unit as claimed in claim 1, wherein the active control board is configured to interpret object and file transfer protocols into actual data transfer to or from the plurality of storage devices.

7. The active storage unit as claimed in claim 1, wherein the active control board comprises an operating system configured to run distributed file system software.

8. The active storage unit as claimed in claim 1, wherein the plurality of storage devices comprise at least one of a group consisting of hard disk drives (HDDs), hybrid HDDs, solid state drives (SSDs) and hybrid SSDs for storing block-based data.

9. The active storage unit as claimed in claim 1, wherein the active control board further comprises-a non-volatile random access memory (NVRAM) controller configured to control at least one NVRAM module coupled thereto, the processor using the NVRAM controller to write cache data into the at least one NVRAM module in an event of a power disruption and, after power resumption, reloading cache data from the NVRAM module to resume processing.

10. The active storage unit as claimed in claim 1, wherein the active control board further comprises an inter-integrated circuit (I²C) communicatively coupled to the processor, an I²C bus communicatively coupled to the I²C from a back plane board.

11. An active storage array comprising:
a backplane board;
one or more active storage units, each active storage unit comprising:
an active control board comprising a processor, at least one internal memory module communicatively coupled to the processor, a microprocessor communicatively coupled to the processor, and a bus communicatively coupled to the microprocessor from the backplane board, and a reconfigurable logic circuit communicatively coupled to the processor for programming the active storage unit; and
a plurality of storage devices communicatively coupled to the active control board, wherein the active control board further comprises a media controller communicatively coupled to the processor and the plurality of storage devices for enabling the processor to control access to the plurality of storage devices; and
one or more switch control boards interfacing between the one or more active storage units and external devices, thereby allowing data operations directly between the external devices and the one or more active storage units, each of the one or more switch control boards comprising a microcontroller unit (MCU) communicatively coupled to the processor of each of the one or more active storage units for enabling management operations of the one or more active storage units by the MCU.

12. The active storage array as claimed in claim 11, further comprising an Ethernet connection, wherein the back plane board is further configured to receive the one or more active storage units and the one or more switch control boards, wherein the one or more active storage units and the one or more switch control boards are hot-pluggable to the back plane board, and wherein the microprocessor on each active control board is coupled to the Ethernet connection.

13. An active storage array comprising:
one or more active storage units, each active storage unit comprising:
an active control board comprising a processor, at least one internal memory module communicatively coupled to the processor, and a reconfigurable logic circuit communicatively coupled to the processor for programming the active storage unit; and
a plurality of storage devices communicatively coupled to the active control board;
one or more switch control boards interfacing between the one or more active storage units and external devices, thereby allowing data operations directly between the external devices and the one or more active storage units; and
a plurality of switch control boards each interfacing between respective one or more active storage units and the external devices and each comprising a network switch communicatively coupled to a switch controller module.

14. The active storage array as claimed in claim 13, wherein the plurality of switch control boards are configured to cooperate with each other, via the network switch, to form a distributed active storage array.

15. An active storage array comprising:
one or more active storage units, each active storage unit comprising:
an active control board comprising a processor, at least one internal memory module communicatively coupled to the processor, and a reconfigurable logic circuit communicatively coupled to the processor for programming the active storage unit; and
a plurality of storage devices communicatively coupled to the active control board; and
one or more switch control boards interfacing between the one or more active storage units and external devices, thereby allowing data operations directly between the external devices and the one or more active storage units, wherein the one or more switch control boards each comprises a chassis management processor communicatively coupled to the network switch and configured to power on active control boards of the one or more active storage units in phases via a power switch disposed in each of the active control boards.

16. The active storage unit as claimed in claim 2, wherein the plurality of storage devices comprise block-based storage media.

17. The active storage unit as claimed in claim 2, wherein the reconfigurable logic circuit is programmable on-the-fly for changing the functions and features of the active storage unit.

18. The active storage unit as claimed in claim 1, wherein the active control board is configured to execute software programs which control the various hardware devices on the active control board to achieve one or more functions selected from the group comprising (a) perform commands, status and data exchanges with other active control boards accessible through internal and external network switches using distributed file system and other system and application software to self-form and maintain a distributed storage cluster and (b) maintain information on the active control board's participation in storage resources of the active storage unit for reinstatement of the storage resources after a power failure.

19. The active storage array as claimed in claim 11, wherein data redundancy is achieved by replicating data across all active control boards within a storage volume.
